(19) United States
(12) Patent Application Publication
(10) Pub. No.: US 2021/0073930 A1
(43) Pub. Date: Mar. 11, 2021

(54) COMMERCIAL REAL ESTATE EVALUATION, VALUATION, AND RECOMMENDATION

(71) Applicant: Evalyoo, Inc., Irvine, CA (US)

(72) Inventor: Manuchehr Khoshbin, Irvine, CA (US)

(73) Assignee: Evalyoo, Inc., Irvine, CA (US)

(21) Appl. No.: 17/014,709

(22) Filed: Sep. 8, 2020

Related U.S. Application Data
(60) Provisional application No. 62/896,489, filed on Sep. 5, 2019.

(51) Int. Cl. G06Q 50/16; G06F 16/2457; G06F 16/29; G06K 9/62; G06N 20/00

(52) U.S. Cl. CPC G06Q 50/163; G06F 16/24578; G06N 20/00; G06F 16/24573; G06K 9/6256; G06F 16/29

(57) ABSTRACT

A real estate evaluation engine may receive a request for relevant properties, receive property information, identify a list of relevant properties, and calculate an estimated value for each property in the list of relevant properties. The evaluation engine may calculate a score for each property in the list of relevant properties. The score may be based on a client profile. The list of relevant properties may be sorted by score and provided to the client. Machine learning may be applied to property evaluation, algorithm selection, and criteria selection.

### CROSS-REFERENCE TO RELATED APPLICATIONS

This application claims priority to U.S. Provisional Patent Application Ser. No. 62/896,489, filed on Sep. 5, 2019.

### BACKGROUND

Many people may want to evaluate commercial real estate. Therefore, there exists a need for a commercial real estate evaluation tool.

### BRIEF DESCRIPTION OF THE SEVERAL VIEWS OF THE DRAWINGS

The novel features of the disclosure are set forth in the appended claims. However, for purpose of explanation, several embodiments are illustrated in the following drawings.

FIG. 1 illustrates an example overview of one or more embodiments described herein, in which a client-specific listing of properties is generated;

FIG. 2 illustrates an example overview of one or more embodiments described herein, in which a property is evaluated to determine an estimated value;

FIG. 3 illustrates an example overview of one or more embodiments described herein, in which a property is evaluated to generate a client-specific score;

FIG. 4 illustrates an example graphical user interface (“GUI”) of one or more embodiments described herein, in which various search criteria are received;

FIG. 5 illustrates an example GUI of one or more embodiments described herein, in which a listing of results is provided;

FIG. 6 illustrates an example environment in which one or more embodiments, described herein, may be implemented;

FIG. 7 illustrates a flow chart of an exemplary process for generating a listing of evaluated properties, in accordance with some embodiments;

FIG. 8 illustrates a flow chart of an exemplary process for evaluating a property, in accordance with some embodiments;

FIG. 9 illustrates a flow chart of an exemplary process for applying machine learning to property evaluation, in accordance with some embodiments; and

FIG. 10 illustrates a schematic block diagram of one or more exemplary devices, in accordance with one or more embodiments described herein

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to evaluate commercial real estate listings. Such evaluation may include generating an estimated property value and a client-specific score for each evaluated property. Some embodiments may collect feedback and apply machine learning to algorithms used for value estimation and property scoring.

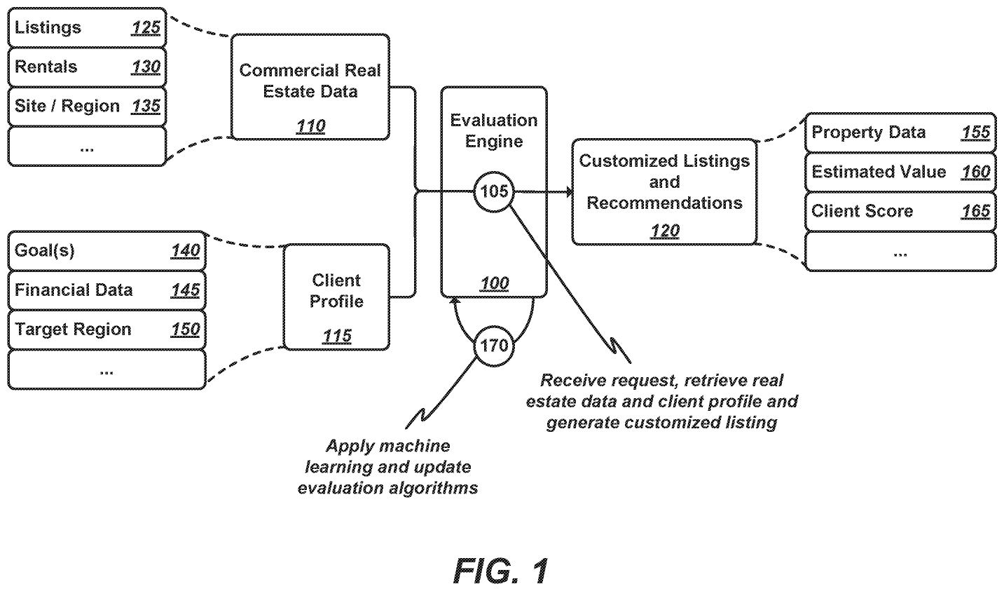

FIG. 1 illustrates an example overview of one or more embodiments described herein, in which a client-specific listing of properties is generated. Although various elements are referred to as “client-specific” above and below, such elements may be generated or utilized in association with default or missing client data. In some cases, client-specific data may include data included in, based on, or otherwise extracted from, a request. For instance, client profile information may be limited to a geographic region specified in a request. As shown, an evaluation engine 100 of some embodiments may receive (at 105) commercial real estate data 110 and client profile information 115 (if available). The data may be received from local or remote repositories, network-accessible resources, and/or other appropriate resources.

Data may be received (at 105) based on a request received from a client. A client may include, implement, and/or utilize one or more applications, interfaces, websites, and/or other resources to access the evaluation engine 100. Such clients may access the evaluation engine 100 locally or via one or more network pathways.

The received request may include, for instance, client identifying information (e.g., username and password), area information (e.g., a ZIP code, neighborhood, region, etc.), other filter information (e.g., price range, minimum size, etc.), and/or other appropriate information (e.g., investment purpose, improvement budget, etc.). In some cases, the request may be associated with a particular property (e.g., the request may include a street address) or set of properties. In this way, a client may evaluate specific properties under consideration, or properties in an existing portfolio.

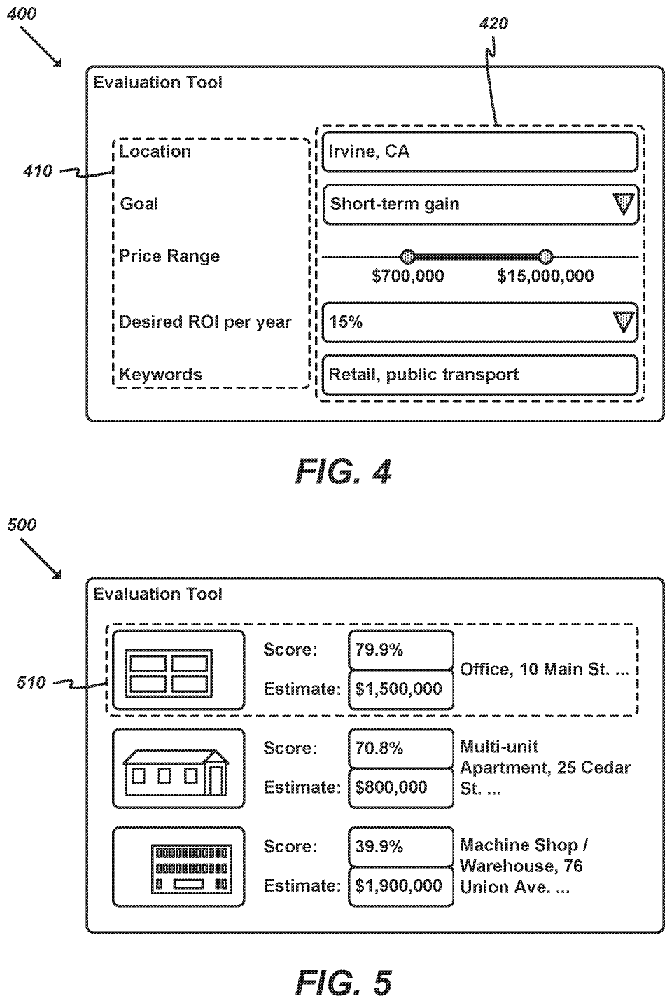

As an example, a particular client may submit a request for rental properties located in the city of Irvine, Calif., with an asking price less than one million two hundred thousand dollars and at least three rental units. Requests may be received from or via various appropriate resources, such as client device applications, web sites, APIs, etc. For instance, FIG. 4 below describes a graphical user interface (“GUI”) that may be able to receive client requests.

Returning to FIG. 1, commercial real estate data 110 may include, for instance, listing information 125, rental information 130, site and/or region information 135 and/or other appropriate information. Commercial real estate data 110 may include current and historical data. Listing information 125 may include information such as sales price, lot size, square footage, year built, and/or other appropriate information. Listing information 125 may be retrieved from sources such as commercial listing sites or services, local advertising, surveys, and/or other appropriate sources.

Rental data 130 may include, for instance, current rents, offered rental rates, trends, occupancy rates, and/or other appropriate rental information. Rental data 130 may be collected from various sources, such as surveys, listing sites or services, advertisements, and/or other appropriate sources.

Site and region data 135 may include information such as, for instance, tax rates, assessed values, replacement cost, zoned uses, amenities or services, etc. Region information may further include information such as population trends, crime rates, comparison to other markets (e.g., rents over/under market), and/or other appropriate information.

Other examples of commercial real estate data 110 include, for instance, interest rates, loan qualification guidelines or targets, current market conditions, historical sales volume, historical sales price, market predictions, planned development or improvements, etc.

Thus, continuing the example of the particular client above, commercial real estate data 110 may be retrieved for rental properties within the city of Irvine that satisfy the specified criteria (i.e., asking price and minimum rental units). Depending on the amount of information retrieved based on a particular request, filter values may be adjusted or otherwise manipulated such that an appropriate number of data points is identified. For instance, sales price range may be expanded to include additional properties in occupancy or expected rental rate calculations.

Client profile data 115 may include, for instance, investment goals 140, financial data 145, target region 150, and/or other appropriate information. In some cases, a default client profile 115 may be used, such as when no client-specific information is provided.

Investment goals 140 may include, for instance, one or more types of investment goal (e.g., future development, fixed income, value add or re-sell value, etc.) and/or other investment goal information (e.g., desired income, desired appreciation, etc.). Financial data 145 may include, for instance, available capital for down payment and/or improvements, available credit, credit score or other borrower rating information, and/or other relevant information. Target region information 150 may include, for instance, a selection of towns, ZIP codes, other geographic region (e.g., within five miles of a specified location), and/or other appropriate target region information. Other client profile information 115 may include, for instance, keywords or other search criteria (e.g., “downtown”, “corner lot”, “fixer-upper”, etc.), previous purchase and/or sale information, search or request history, and/or other relevant information. Client profile information 115 may be automatically retrieved from various resources using various provided credentials (e.g., banking, or other financial information may be automatically downloaded based on a provided username and password).

The customized listings and recommendations 120 may include a property listing with property data 155, estimated value 160, client-specific score 165, and/or other appropriate information. For instance, FIG. 5 below, describes an example GUI that may be used to provide customized listings and recommendations 120. Estimated value 160 and client-specific score 165 may be generated using a process such as process 800 described below.

Property data 155 may include site or building information (e.g., size, fixtures, etc.), location information, and/or other appropriate information. Estimated value 160 may include a calculated valuation, confidence score, historical valuations, predicted future valuations, and/or other appropriate value information (e.g., difference between estimated value and selling price). Client score 165 may include a client-specific score or ranking of each listed property. The client score 165 may be normalized (e.g., on a scale of zero to one hundred per cent) or presented as a grade or discrete value (e.g., “A”, “B”, “F”, “Recommended”, “Acceptable”, “Avoid”, etc.). For client-owned properties, ratings may be mapped to recommendations such as “hold”, “improve”, or “sell”. The customized listings and recommendations 120 may include other elements, such as pictures and/or videos, property description or notes, keywords, etc.

Thus, continuing the example of the particular client above, the retrieved commercial real estate data 110 may be evaluated to identify a list of relevant properties. Such relevant properties may match at least one request criteria (e.g., property type, price range, etc.) or otherwise be selected by the evaluation engine 100 based on client profile information or request information. Each relevant property may be evaluated to generate a valuation and a score. The list of relevant properties and associated valuations and scores may be sorted and presented based on score, value, asking price, and/or other relevant criteria. Thus, rental properties with at least three units and selling for less than one million two hundred thousand dollars may have higher scores than other property types (e.g., industrial, open lot, etc.) or properties priced higher than one million two hundred thousand dollars.

In some embodiments, the evaluation engine 100 may apply (at 170) machine learning and update evaluation and/or recommendation algorithms. Such machine learning will be described in reference to process 900 below. Machine learning may be based on updated commercial real estate data 110. For instance, if a property sale is recorded, the actual selling price may be recorded and compared to estimated selling value in order to train the machine learning model(s). As another example, a client may provide feedback after viewing one or more recommended properties. Such feedback may include a score or grade for each property which may be compared to the score or grade generated by the evaluation engine 100 in order to train the machine learning model(s).

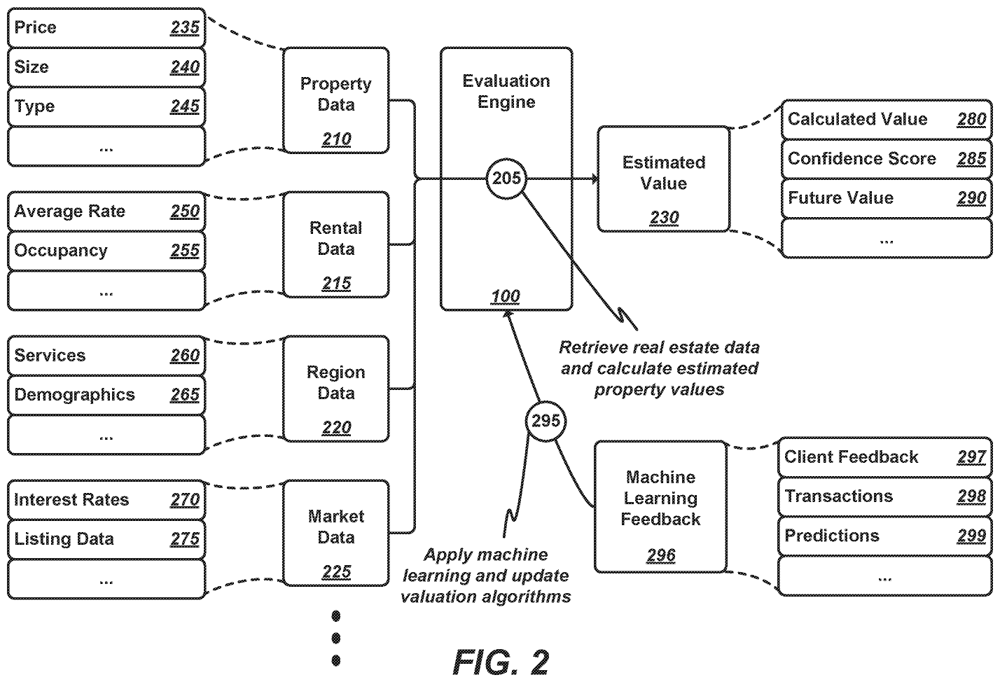

FIG. 2 illustrates an example overview of one or more embodiments described herein, in which a property is evaluated to determine an estimated value. Such evaluation may be performed for each relevant property or listing in the customized listings and recommendations 120 (and/or other relevant properties or listings). As shown, the evaluation engine 100 may retrieve (at 205) real estate data and calculate estimated property values. The real estate data may include property data 210, rental data 215, region data 220, market data 225, and/or other data. Such data may be received from local and/or remote resources.

The property data 210 may include information such as selling price 235, size 240, type 245, etc. The rental data 215 may include information such as average rate 250, occupancy 255, and/or other appropriate information. The region data 220 may include information such as available services 260 (e.g., water, sewer, gas, electric, etc.) and/or service capacities (e.g., two hundred amp electrical service), demographic information 265 (e.g., share of area properties that are zoned for various uses, average annual sales for businesses, annual household income for residents of rental properties, etc.), and/or other appropriate information (e.g., population trends, local industries or employers, etc.). Market data 225 may include, for instance, interest rates 270, listing information 275 (e.g., number of active listings, average time on market, etc.), and/or other appropriate market information.

The estimated value 230 may be provided as a single number representing a calculated value 280 (e.g., seven hundred thousand dollars). Some embodiments may include a confidence score 285, a future value prediction 290, and/or other appropriate elements that may help define the estimated value 230 or estimated selling price.

The calculated value 280 may be generated in various ways, using various appropriate operations. For instance, some embodiments may include a sum of multiple weighted factors and associated values. As an example, a land value may be generated based on lot size and/or other appropriate factors (e.g., available services, road frontage, etc.). As another example, a building value may be generated based on building size, structure type, materials, and/or other relevant factors, if known. As still another example, other relevant features may be associated with a value (e.g., proximity to freeway, access to facilities such as airports, etc.). The various values may be summed to generate a calculated value 280, where the individual factor values or coefficients may be further smoothed, limited, or otherwise manipulated depending on the individual factor values or summed calculated value 280.

The confidence score 285 may indicate a relative confidence in an estimated value 280. The confidence score 285 may be provided as a rating (e.g., from zero to one hundred per cent confidence) or other appropriate value. The confidence score 285 may be calculated based on the breadth and depth of available data. For instance, a calculated value 280 based on hundreds of comparable property sales may have a relatively higher confidence score 285, while a valuation based on one or two comparable sales may have a relatively lower confidence score. As another example, a calculated value 280 based on in-depth property data (e.g., finish materials, structural details, etc.) may have a relatively higher confidence score 285 compared to a property with limited available data (e.g., only location and building size) may have a relatively lower confidence score 285.

The future value 290 may be generated based on various relevant factors, such as regional population trends, historical appreciation rates, property type, etc. Some embodiments may provide multiple future value estimates 290 (e.g., one year, two years, or ten years into the future).

In some embodiments, the evaluation engine 100 may apply (at 295) machine learning and update or generate valuation algorithms used by some embodiments. Machine learning feedback 296 may include, for instance, client feedback 297, transaction data 298, predictions 299, and/or other relevant information. Client feedback 297 may include, for instance, survey data, offer information, and/or other relevant information. Transaction data 298 may include, for instance, sale price, sale date, and/or other relevant transaction information. Prediction data 299 may include lists of properties and associated calculated value 280, confidence score 285, and/or future value 290 predictions. Predictions may be compared to actual data and machine learning models may be trained based on the actual and predicted values. For instance, comparison of predicted value to sales price may indicate that year of construction has a greater effect on value than current prediction models indicate. As such, a weighting coefficient of a portion of calculated value 280 associated with year of construction may be increased relative to other coefficients.

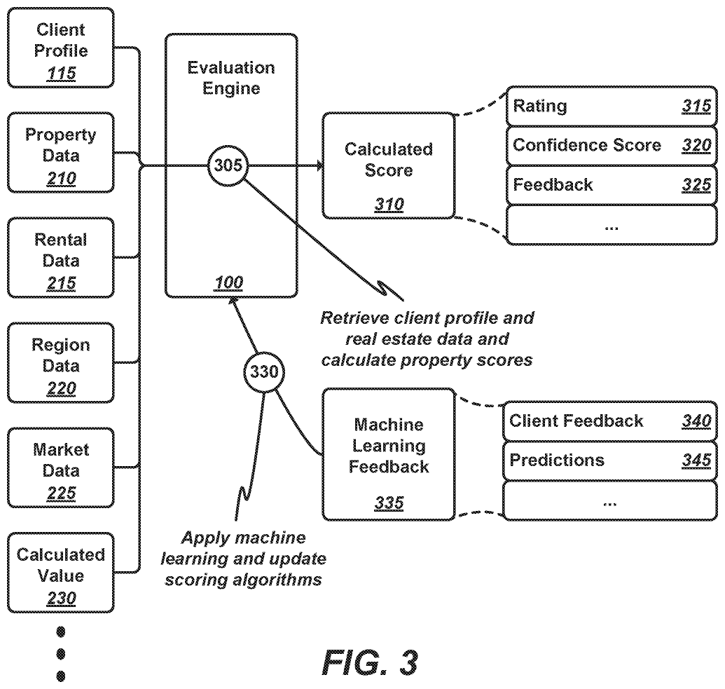

FIG. 3 illustrates an example overview of one or more embodiments described herein, in which a property is evaluated to generate a client-specific score. Such evaluation may be performed for each relevant property or listing in the customized listings and recommendations 120 (and/or other relevant properties or listings). As shown, the evaluation engine 100 may retrieve (at 305) the client profile 115, estimated value 230, and real estate data in order to calculate property scores. The real estate data may include property data 210, rental data 215, region data 220, market data 225, and/or other data. Such data may be received from local and/or remote resources.

The calculated score 310 may be generated based on evaluation of estimated value 230 versus price (e.g., “upside” value), client profile information 115 including investment goals, available resources, etc. Such information may be compared to attributes of each property in the customized listings and recommendations 120 and a weighted percentage score may be calculated based on matching between client profile information 115 and property information. Factors used for comparison to generate the calculated score 310 may include, for instance, investment goal, desired price range, available down payment, financing, return on investment, time to recoup investment, etc.

Different scenarios may include various relevant factors (and/or factor weightings) in the generation of the calculated score 310. For instance, value of existing structures may be irrelevant to a developer and thus not included in score calculation for the developer but may be highly relevant to a contractor interested in flappable properties and this included in the score calculation.

Each calculated score 310 may include a rating 315, a confidence score 320, individualized feedback 325, and/or other relevant elements. The rating 315 may be a percentage score (e.g., from zero to one hundred per cent) or other ranking. The confidence score 320 may indicate a relative confidence in a rating 315. The feedback 320 may include feedback or notations related to client matching (e.g., “prime downtown location”, “ideal for flip”, etc.).

The evaluation engine 100 may apply (at 330) machine learning and update scoring algorithms based on machine learning feedback 335. The machine learning feedback 335 may include client feedback 340, predictions 345, and/or other relevant information. For instance, client feedback 340 may include indications of whether recommended listings (e.g., listings with a higher score) were appropriate or desirable to the client. As another example, predictions 345, including calculated scores 310 may be compared to actual purchases (or offers) made by a client. Thus, for instance, if a property with a relatively high score 310 is eventually purchased, the prediction algorithm may be reinforced or validated. Conversely, if a property with a relatively low score 310 is purchased, the prediction algorithm may be updated such that a higher score would be generated for that property.

FIG. 4 illustrates an example graphical user interface (“GUI”) 400 of one or more embodiments described herein, in which various search criteria are received. As shown, the GUI 400 may include various prompts 410 and associated response features 420. In this example, prompts 410 and associated response features 420 include location, investment goal, price range, desired return on investment, and keywords. Different embodiments may include different request elements in GUI 400. A similar GUI may be provided to collect user profile information that may be applied to multiple requests. For instance, user profile information may include available funds, loan qualifications, improvement skills or access to contractors, etc.

FIG. 5 illustrates an example GUI 500 of one or more embodiments described herein, in which a listing of results is provided. As shown, GUI 500 may include a number of property summaries 510, each including various features, such as calculated score, estimated value, pictures or videos, notes or information, etc. Each summary 510 may include selectable elements that may provide more detail (e.g., explanation of score, factors used in value calculation, detailed property information such as size or amenities, etc.). The listings 510 may be sorted by calculated score, value, upside value, sales price, and/or other relevant parameters.

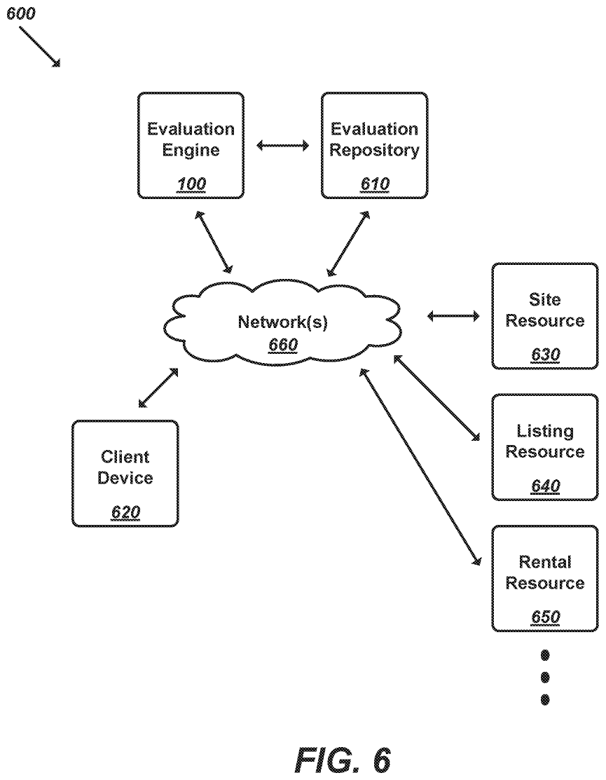

FIG. 6 illustrates an example environment 600 in which one or more embodiments, described herein, may be implemented. As shown, the environment 600 may include the evaluation engine 100, an evaluation repository 610, one or more client devices 620, various resources 630-650, and a network 660.

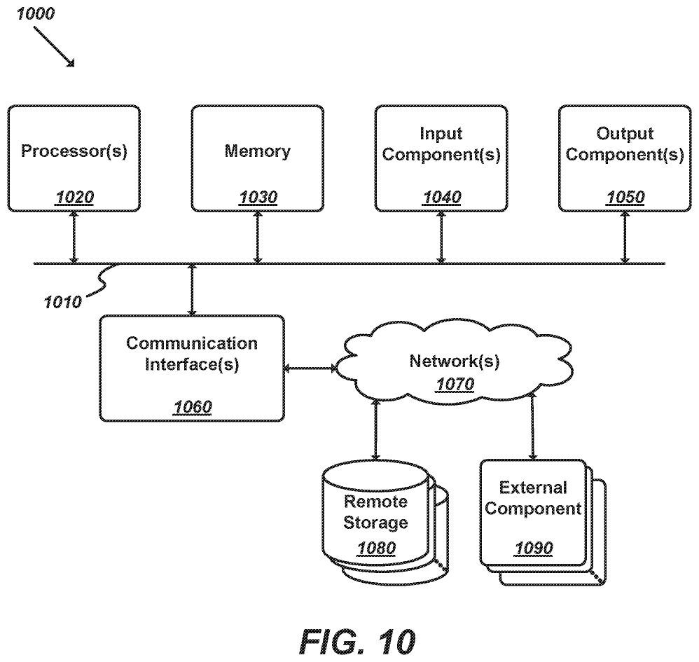

The evaluation engine 100 may be implemented using various electronic devices, such as those described below in reference to FIG. 10. The evaluation repository 610 may store instructions and/or data related to property evaluation, as performed by some embodiments. For instance, the evaluation repository 610 may include various evaluation and/or scoring algorithms. As another example, the evaluation repository 610 may include previously generated valuation and/or score entries. As still another example, the evaluation repositor 610 may include listings of data sources or other resources.

Each client device 620 may be an electronic device such as a smartphone, tablet, personal computer, laptop, wearable device, etc. that is capable of executing instructions, processing data, communicating across one or more networks 660, and/or otherwise performing various actions described herein. The client device 620 may be implemented using various electronic devices, such as those described below in reference to FIG. 10. The client device 620 may include various user interface (UI) elements, such as buttons, keypads, touchscreens, speakers, microphones, cameras, displays, indicators, etc.

The various resources 630-650 may include resources such as search engines, databases, etc. The resources 630-650 may be accessed via various appropriate pathways (e.g., using one or more application programming interfaces (APIs), via a webhook or other uniform resource locator (URL) based resource, by authenticating at a server with a username and password, etc.).

Site resources 630 may include or provide various resources associated with sites, lots, structures or buildings, and/or other such property information. Site resources 630 may include, for instance, government databases that may include information related to properties within a region (e.g., tax or assessment information, permit information, lot size, public services, structure information, etc.).

Listing resources 640 may include or provide various resources associated with listings of properties for sale. Such listing resources 640 may include information such as, for instance, sales price, features or amenities, etc. Listing resources 640 may also provide, augment, or confirm information such as tax rate, assessed value, lot and structure sizes, homeowner's association (“HOA”) fees, etc.

Rental resources 650 may include or provide various resources associated with rental listings and/or data. Such listings may include, for instance, site, building, or unit information (e.g., size, features, etc.), rental information (e.g., monthly rate, lease term, etc.), rental data (e.g., occupancy rates, price trends or averages, etc.).

The network(s) 660 may include various wired, wireless, cellular, distributed (e.g., the Internet), and/or other types of network communication pathways available to the various elements of environment 600.

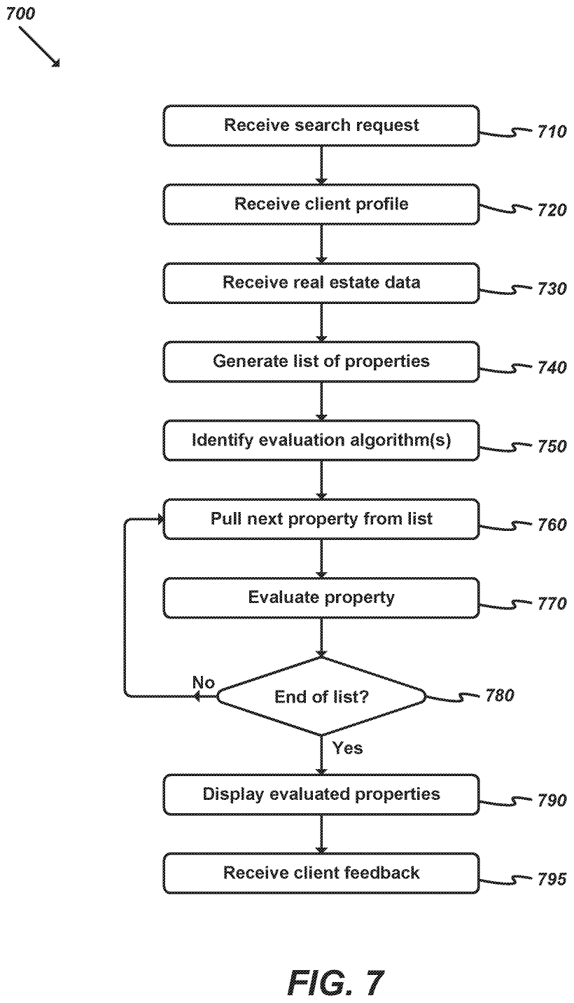

FIG. 7 illustrates an example process 700 for generating a listing of evaluated properties, in accordance with some embodiments. The process may generate a ranked list of properties that optimize potential upside value and meet, match, or otherwise satisfy some or all of the request criteria. The process may be performed when a request is received, when a web portal or API of some embodiments is activated, when a client launches a client device application of some embodiments, and/or under other appropriate conditions. In some embodiments, process 700 may be performed by evaluation engine 100.

As shown, process 700 may include receiving (at 710) a search request or query. Such a request may be received via an element such as GUI 400, or through another user interface, an API, and/or via other appropriate resources. The search request may include various search criteria, client identification, and/or other relevant information, such as request source (e.g., application, website, API call, etc.).

The process may further include receiving (at 710) a client profile. The client may be identified based on the received request. For example, the request may be submitted in a formatted message that includes a username and password. The client profile 115 may be stored locally at the client device 620 or at a resource such as evaluation engine 100. The client profile may include data related to desired property attributes (e.g., type—rental, industrial, retail, etc., price, size, location, etc.), client qualifications (e.g., available funds, mortgage qualification, etc.), client demographic data (e.g., age, occupation, etc.), and/or other appropriate information (e.g., preferred listing agent, management company, etc.).

The preferences may be stored as elements of a client profile 115. Some embodiments of the evaluation engine 100 may collect such client profile information through a survey or intake form, and/or other appropriate ways. In addition, client preferences may be based at least partly on preferences or other data related to similar clients or a default client profile.

Process 700 may also include receiving (at 730) real estate data 110. Real estate data may be retrieved from evaluation repository 610 and/or one or more local or remote resource 630-650. Real estate data 110 may be updated in real-time or near real-time, at regular intervals, upon receipt of a request, and/or other appropriate conditions. Real estate data 110 may include property data 210 including listing information, rental data 215, region data 220, market data 225, and/or other appropriate information. For property-specific evaluations, a client may provide real estate data for one or more properties. For instance, a client may specify improvements made to a client-owned property in order to generate an updated estimated value.

Process 700 may additionally include generating (at 740) a list of properties for further evaluation. Commercial real estate data 110 may be filtered or otherwise limited based on the received request or client profile information (e.g., only listings from a specified area, or listings in a specified price range, may be retrieved for further analysis and evaluation). Depending on the number of properties identified for inclusion in the list of properties, filter criteria may be automatically adjusted (e.g., by expanding or narrowing a geographic area, by increasing or decreasing a price range, etc.) such that a specified number of listings is generated for evaluation.

Process 700 may further include identifying (at 750) one or more evaluation algorithms and/or parameters to be applied to the list of properties. The evaluation algorithms may be associated with value estimation, score generation, and/or other appropriate evaluation operations (e.g., filtering results, ranking or sorting values, etc.). Evaluation parameters may include sets of equations, coefficients, offsets, etc. that may be used to evaluate the list of properties generated at 740. Selection of evaluation algorithms and/or parameters may be based on machine learning models or other artificial intelligence (“AI”) features.

Process 700 may also include pulling (at 760) the next property from the list of properties for evaluation. Each property in the list may have an associated identifier or code that uniquely identifies the property. In addition to an identifier, the list of properties may include data for evaluation, references to evaluation data, and/or other appropriate information that may allow evaluation of listed properties.

Process 700 may additionally include evaluating (at 770) the property. The process may execute one or more evaluation algorithms using the evaluation parameters and client profile information to generate an estimated value and a client-specific score for the property. The estimated value and client-specific scores may be generated using a process such as process 800 described below.

Process 700 may further include determining (at 780) whether the end of the list of properties has been reached. The list of properties may include metadata such as a number of included listings or the list may be read from a first listing, iterating through each additional listing until no more listings are available. If the process determines (at 780) that the end of the list has not been reached, the process may pull (at 760) the next property from the list of properties.

If the process determines (at 780) that the end of the list has been reached, the process may display (at 790) the listing of properties with the associated estimated values and client-specific scores. The results may be provided via an element such as UI 500.

The client-specific score may be calculated based on comparable listings (e.g., currently for sale or recently sold), calculated replacement cost for the property, and/or other relevant factors. A higher score indicates a higher upside potential for a particular property.

The evaluation scores may be based on various appropriate factors, such as lot size, building size, last sale date and amount, occupancy statistics (e.g., current occupancy rate, rate history, etc.), year built, actual rent, market rent, market price per square foot, replacement cost, property price per square foot, ratio of building size to lot size, owner information, location score, demographic information, population information, historical prices, etc. A higher score may indicate that the associated property has higher upside potential and/or that the property more closely matches desired characteristics indicated by the client.

Process 700 may additionally include receiving (at 795) client feedback. Such client feedback may be received via selections or indications received from the client. For instance, a client may indicate interest in one or more listed properties. As another example, a client may update a search request based on received results. Such feedback may be applied to machine learning as described above and below.

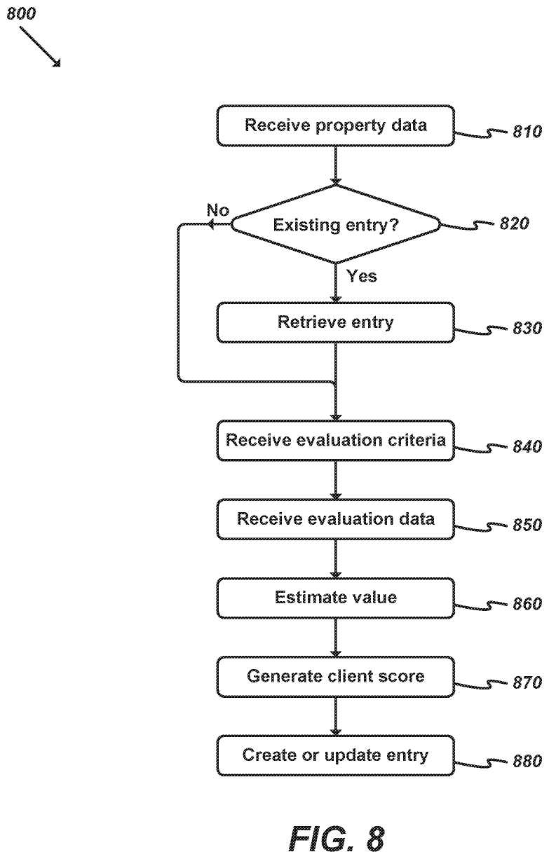

FIG. 8 illustrates an example process 800 for evaluating a property by generating a value estimate and a client-specific score. The process may use various evaluation algorithms to evaluate real estate data associated with the property. In some embodiments, the process may utilize client profile information to select and/or execute the various evaluation algorithms. The process may be performed when a property is identified for evaluation. In some embodiments, process 800 may be performed by evaluation engine 100.

As shown, process 800 may include receiving (at 810) the property data. The property data may be specified by a property identifier or other identifying information (e.g., a street address) or may be received directly (e.g., from the generated list of properties). The received property data may include associated information, evaluation criteria, and/or other relevant associated information.

Process 800 may further include determining (at 820) whether the received property is associated with an existing entry. Such a determination may be made by evaluating a listing of property entries to identify matching information (e.g., street address). If the process determines (at 820) that the received property is associated with an existing entry, the process may include retrieving (at 830) the entry. Such an entry may include property data, previous evaluations associated with the property, and/or other relevant information. Such entries may further include client evaluations or notes (e.g., a client that visits a property may confirm or refute information associated with the property). For instance, a client may visit a site and confirm that construction has completed, improvements have been initiated, brush or debris has been cleared, etc.

Process 800 may additionally include receiving (at 840) evaluation criteria for the property. Such evaluation criteria may include, for instance, selection of one or more evaluation algorithms, equations, calculations, coefficients, parameters, factors, etc. that may be used to generate valuations, client-specific scores, and/or other evaluation data. If no specific evaluation criteria are available, default criteria may be utilized.

Process 800 may further include receiving (at 850) evaluation data. Such evaluation data may include property-specific data, rental data, regional data, market data, financial information, and/or other appropriate data. Some or all evaluation data may be included in a property entry of some embodiments. Evaluation data may be received from various other resources, such as web portals, listing databases, financial information sites, etc.

Process 800 may also include estimating (at 860) a value of the received property. The value may be estimated using the evaluation criteria received (at 840), the evaluation data received (at 850), and/or the property data received (at 810) or retrieved (at 830). The evaluation criteria may be modified based on available evaluation data. For instance, if access to a building interior is not available, factors or algorithms associated with interior fixtures, finish materials, etc. may be removed from the evaluation and other factors may be weighted more heavily. In some embodiments, if property-specific information is not available, default or typical values may be used.

Value may be calculated based on factors such as price per square foot, replacement cost, rental income (actual and/or potential), occupancy rate, and/or other relevant factors, such as those described in reference to FIG. 2 above.

Process 800 may additionally include generating (at 870) a client-specific score for the received property. In addition to or in place of the data and algorithms used to generate (at 860) an estimated value, the client-specific score may utilize client profile information. Whereas the property values are estimated independent of any client profile information, the client-specific score may be used to rank matching properties (e.g., those within a specified price range) according to generic criteria and/or client-specific criteria.

The client-specific score may be based on factors such as upside potential, investment goal, return on investment, resources, etc. Various factors may be generated based on other values (whether specified or calculated). For instance, a factor in upside potential may be a difference between an estimated value of a property and a listed sales price of the property. As another example, a factor in upside potential may be a ratio of monthly rental income to investment amount. Some embodiments of the evaluation engine 100 may provide multiple scoring pipelines associated with various investment strategies (e.g., future development, fixed income, value add, etc.). Multiple scores may be generated, using multiple different algorithms, for each property, as indicated by client preferences, evaluation criteria, and/or other relevant factors.

Process 800 may further include creating or updating (at 880) an entry associated with the property under evaluation. Such an entry may include estimated values, client-specific scores, property information, etc. Such entries may be used for future evaluations, machine learning (e.g., model training), and/or various other operations.

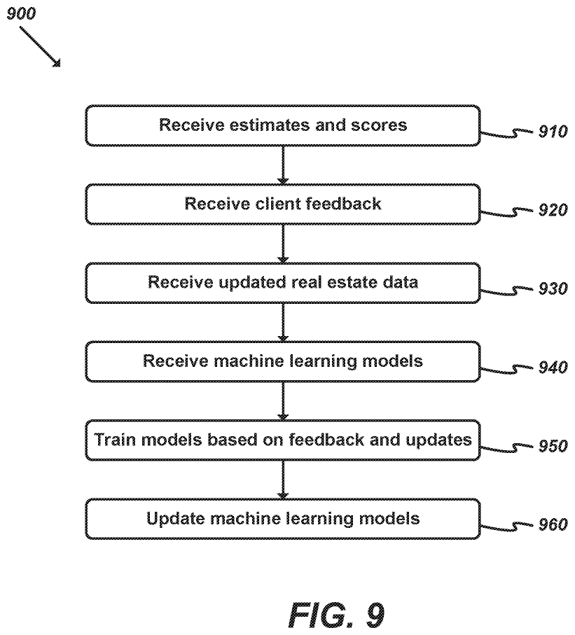

FIG. 9 illustrates an example process 900 for applying machine learning to property evaluation. The process may be used to update evaluation criteria including evaluation algorithms, equations, coefficients, factors, etc. The process may be performed at regular intervals, when feedback becomes available, and/or other appropriate conditions. In some embodiments, process 900 may be performed by evaluation engine 100.

As shown, process 900 may include receiving (at 910) estimates, scores, and/or other recommendations or evaluation data. Such estimated values and client-specific scores may be received from a resource such as evaluation repository 610. In addition to the estimates and scores, some embodiments may retrieve associated evaluation algorithms, criteria, values, parameters, etc. that were used to generate the estimates and/or scores.

Process 900 may further include receiving (at 920) client feedback. Such feedback may be received via surveys, client selections, updates to search requests, and/or other appropriate resources. For instance, if a client selects a particular listed property for in-depth evaluation, the selection may be an indication that the property recommendation algorithm or criteria was accurate. As another example, if a client updates a search without selecting any listed properties, the update may be an indication that the original results were not attractive options to the client.

Process 900 may also include receiving (at 930) updated real estate data. For instance, listing, rental, and/or sales information may be updated at regular intervals (e.g., daily).

Process 900 may additionally include receiving (at 940) machine learning models associated with the various evaluation algorithms and/or criteria. For instance, such models may be associated with algorithm selection, parameter weighting, filter values, score or value calculation, and/or other operations of evaluation engine 100.

Process 900 may further include training (at 950) the models based on feedback and updates. For instance, actual sales prices may be compared to estimated values to train value estimation models, including models associated with value calculation, selection of value estimation algorithms, weighting of property attributes or factors, etc. As another example, client feedback may be compared to calculated scores to train property scoring models, including models associated with score calculation, selection of scoring algorithms, weighting of factors, etc.

Process 900 may also include updating (at 960) the machine learning models based on the model training. Such updates may include updates to algorithms, coefficients, factors, attributes, etc.

One of ordinary skill in the art will recognize that processes 700-900 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

FIG. 10 illustrates a schematic block diagram of an exemplary device (or system or devices) 1000 used to implement some embodiments. For example, the components described above in reference to FIG. 1, FIG. 2, FIG. 3, FIG. 4, FIG. 5, and FIG. 6 may be at least partially implemented using device 1000. As still another example, the processes described in reference to FIG. 7, FIG. 8, and FIG. 9 may be at least partially implemented using device 1000.

Device 1000 may be implemented using various appropriate elements and/or sub-devices. For instance, device 1000 may be implemented using one or more personal computers (PCs), servers, mobile devices (e.g., smartphones), tablet devices, wearable devices, and/or any other appropriate devices. The various devices may work alone (e.g., device 1000 may be implemented as a single smartphone) or in conjunction (e.g., some components of the device 1000 may be provided by a mobile device while other components are provided by a server).

As shown, device 1000 may include at least one communication bus 1010, one or more processors 1020, memory 1030, input components 1040, output components 1050, and one or more communication interfaces 1060.

Bus 1010 may include various communication pathways that allow communication among the components of device 1000. Processor 1020 may include a processor, microprocessor, microcontroller, digital signal processor, logic circuitry, and/or other appropriate processing components that may be able to interpret and execute instructions and/or otherwise manipulate data. Memory 1030 may include dynamic and/or non-volatile memory structures and/or devices that may store data and/or instructions for use by other components of device 1000. Such a memory device 1030 may include space within a single physical memory device or spread across multiple physical memory devices.

Input components 1040 may include elements that allow a user to communicate information to the computer system and/or manipulate various operations of the system. The input components may include keyboards, cursor control devices, audio input devices and/or video input devices, touchscreens, motion sensors, etc. Output components 1050 may include displays, touchscreens, audio elements such as speakers, indicators such as light-emitting diodes (LEDs), printers, haptic or other sensory elements, etc. Some or all of the input and/or output components may be wirelessly or optically connected to the device 1000.

Device 1000 may include one or more communication interfaces 1060 that are able to connect to one or more networks 1070 or other communication pathways. For example, device 1000 may be coupled to a web server on the Internet such that a web browser executing on device 1000 may interact with the web server as a user interacts with an interface that operates in the web browser. Device 1000 may be able to access one or more remote storages 1080 and one or more external components 1090 through the communication interface 1060 and network 1070. The communication interface(s) 1060 may include one or more application programming interfaces (APIs) that may allow the device 1000 to access remote systems and/or storages and also may allow remote systems and/or storages to access device 1000 (or elements thereof).

It should be recognized by one of ordinary skill in the art that any or all of the components of computer system 1000 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1000 may perform various operations in response to processor 1020 executing software instructions stored in a computer-readable medium, such as memory 1030. Such operations may include manipulations of the output components 1050 (e.g., display of information, haptic feedback, audio outputs, etc.), communication interface 1060 (e.g., establishing a communication channel with another device or component, sending and/or receiving sets of messages, etc.), and/or other components of device 1000.

The software instructions may be read into memory 1030 from another computer-readable medium or from another device. The software instructions stored in memory 1030 may cause processor 1020 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

I claim:

1. A device, comprising:
one or more processors configured to:
receive a request for evaluation of commercial real estate, the request comprising an indication of a geographic region;
generate a listing of properties based on the request, the listing of properties comprising at least a first property;
generate an estimated value for the first property; and
display the estimated value.

2. The device of claim 1, wherein generating an estimated value for the property comprises:
receiving property information associated with the geographic region;
receiving property information associated with the first property; and
generating the estimated value based on the received property information associated with the geographic region and the received property information associated with the first property.

3. The device of claim 2, wherein the received property information associated with the first property comprises selling price and building size and the estimated value comprises a difference between the selling price and a calculated value.

4. The device of claim 1, the one or more processors further configured to:
receive a client profile, the client profile comprising an investment goal; and
generate a score for the first property based on the client profile.

5. The device of claim 4, wherein the investment goal comprises future development, fixed income, or re-sell.

6. The device of claim 4, the one or more processors further configured to:
generate, based on the client profile, a score for a second property from the listing of properties;
generate, based on the first property score and the second property score, a ranked list including the first property and the second property; and
display the ranked list.

7. The device of claim 1, the one or more processors further configured to:
receive feedback from a client based on the displayed estimated value;
retrieve at least one machine learning model associated with generation of the estimated model; and
train the at least one machine learning model based on the received feedback.

8. A non-transitory computer-readable medium, storing a plurality of processor-executable instructions to:
receive a request for evaluation of commercial real estate, the request comprising an indication of a geographic region;
generate a listing of properties based on the request, the listing of properties comprising at least a first property;
generate an estimated value for the first property; and
display the estimated value.

9. The non-transitory computer-readable medium of claim 8, wherein generating an estimated value for the property comprises:
receiving property information associated with the geographic region;
receiving property information associated with the first property; and
generating the estimated value based on the received property information associated with the geographic region and the received property information associated with the first property.

10. The non-transitory computer-readable medium of claim 9, wherein the received property information associated with the first property comprises selling price and building size and the estimated value comprises a difference between the selling price and a calculated value.

11. The non-transitory computer-readable medium of claim 8, the plurality of processor-executable instructions further to:
receive a client profile, the client profile comprising an investment goal; and
generate a score for the first property based on the client profile.

12. The non-transitory computer-readable medium of claim 11, wherein the investment goal comprises future development, fixed income, or re-sell.

13. The non-transitory computer-readable medium of claim 11, the plurality of processor-executable instructions further to:
generate, based on the client profile, a score for a second property from the listing of properties;
generate, based on the first property score and the second property score, a ranked list including the first property and the second property; and
display the ranked list.

14. The non-transitory computer-readable medium of claim 8, the plurality of processor-executable instructions further to:
receive feedback from a client based on the displayed estimated value;
retrieve at least one machine learning model associated with generation of the estimated model; and
train the at least one machine learning model based on the received feedback.

15. A method comprising:
receiving a request for evaluation of commercial real estate, the request comprising an indication of a geographic region;
generating a listing of properties based on the request, the listing of properties comprising at least a first property;
generating an estimated value for the first property; and
displaying the estimated value.

16. The method of claim 15, wherein generating an estimated value for the property comprises:
receiving property information associated with the geographic region;
receiving property information associated with the first property; and
generating the estimated value based on the received property information associated with the geographic region and the received property information associated with the first property.

17. The method of claim 16, wherein the received property information associated with the first property comprises selling price and building size and the estimated value comprises a difference between the selling price and a calculated value.

18. The method of claim 15 further comprising:
receiving a client profile, the client profile comprising an investment goal, wherein the investment goal comprises future development, fixed income, or re-sell; and
generating a score for the first property based on the client profile.

19. The method of claim 18 further comprising:
generating, based on the client profile, a score for a second property from the listing of properties;
generating, based on the first property score and the second property score, a ranked list including the first property and the second property; and
displaying the ranked list

20. The method of claim 15 further comprising:
receiving feedback from a client based on the displayed estimated value;
retrieving at least one machine learning model associated with generation of the estimated model; and
training the at least one machine learning model based on the received feedback.
